(19) United States
(12) Patent Application Publication
(10) Pub. No.: US 2015/0097706 A1
(43) Pub. Date: Apr. 9, 2015

(54) CUSTOMIZED AURAL METHOD AND SYSTEM FOR MANAGING THREATS IN AN AIRCRAFT COCKPIT

(71) Applicant: CMX Avionics, LLC, Hancock, MI (US)

(72) Inventors: Warren F. Perger, Hancock, MI (US); William G. Abbatt, Franklin, MI (US)

(73) Assignee: CMX Avionics, LLC, Hancock, MI (US)

(21) Appl. No.: 14/049,593

(22) Filed: Oct. 9, 2013

(51) Int. Cl. G01C 23/00; G01C 5/00; G10L 15/22; G10L 15/00; G10L 13/00

(52) U.S. Cl. CPC G01C 23/00; G10L 15/00; G10L 13/00; G10L 15/22; G01C 5/005
USPC 340/977; 340/971; 704/231; 704/258; 704/275

(57) ABSTRACT

A micro-computer based aircraft system that creates aural messages based upon system-detected threats (e.g., low oil pressure). The messages are unique to the make and model of aircraft. Speech recognition allows the pilot to request aircraft-specific, customized aurally-delivered checklists and to respond via a challenge and response protocol. This permits a hands-free, timely, complete and prudent response to the threat or hazardous situation, while allowing the pilot the relative freedom to do what is paramount: first, fly the airplane (with minimum distraction).

### BACKGROUND OF THE INVENTION

(1) Field of the Invention

One aspect of the disclosure relates to methods and systems to promote flight safety by providing system-generated aural indications of abnormal operational conditions (“threats”) and suggested remedial actions to be taken by the pilot in flight.

(2) Description of Related Art

Piloting an aircraft is a complicated task, with many visual inputs. Improvements in technology have increased the demands on the pilot, particularly in instrument meteorological conditions (IMC). A prime example of this is the global positioning system (GPS). Twenty five years ago, there were no GPS systems as we know them today and so they did not add to the pilot's workload requirement. Now, however, the pilot must, in addition to scanning the traditional instruments/gauges, commit time to the GPS to verify aircraft position (one aspect of “situational awareness”), entering waypoints, etc. This increased workload makes it more difficult to ensure that all the critical sub-system (oil pressure, charging system, vacuum, etc.) instruments and gauges are being monitored.

Extending the GPS example given above, while the pilot is attending to observing and adjusting the GPS, if oil pressure is lost, in most general aviation (GA) aircraft, the only indication would be a deflection in an analog gauge, which can easily be missed for several minutes.

Pilots use checklists to accomplish important functions in the correct order at the correct time. These checklists are, for example, for take-off, landing, before taxi, and for use in emergencies. These checklists occupy at least one of the pilot's hands, as well as the pilot's visual attention, as the checklist is executed. Furthermore, in the event of an emergency, the checklist may be difficult to locate, at a time when seconds are critical.

Among the art considered before filing this patent application are: U.S. patent publication nos. 2003/0048203; 2007/0273556 and U.S. Pat. No. 3,582,949.

### BRIEF SUMMARY OF THE INVENTION

One aspect of the disclosure relates to providing aural indications and warnings to a pilot for a variety of conditions for which it is imperative for safety that the pilot evaluate the situation and if warranted take immediate action depending on the situation and particular characteristics of the aircraft. In effect, several embodiments enable the system to serve as an “electronic co-Pilot”.

In several forms the disclosed system has customized aural checklists that optionally invoke speech recognition or require button interaction. Another aspect of the disclosure automatically creates logbook entries for use by the mechanic and by the pilot, as described hereinafter. This aspect includes automated creation of electronic pilot logbook entries, and (optionally) logging details of abnormal conditions that may be helpful to the mechanic or aircraft inspector post-flight.

Thus the disclosed system relates to improving safety in an aircraft by providing aural alarms (and optionally visual messages) that signal abnormal situations or specific hazards. Several embodiments of the system and method are of particular utility to pilots flying without a co-pilot. It is known for instance that single pilot flight under instrument flight rules (“IFR”) or in instrument meteorological conditions (“IMC”) may involve heavy workloads in the cockpit. The disclosed system may alleviate stress in such situations.

Among the features and optional steps of the disclosed system and method are:
providing prompt aural warnings for common equipment failures in an aircraft;
providing such warnings as customized for the make and model of the aircraft being flown;
providing speech recognition as the main means by which the pilot acknowledges an aural message or requests the system for an action, such as providing a customized checklist; and
creating automated pilot and mechanic log book entries for flights.

The provision of an aural warning would give the pilot precious minutes to take the action appropriate to the situation. For example, attending to a loss of engine oil pressure is far more critical than attending to the GPS, yet without an aural input, is likely to go unnoticed.

This logic can be extended to several other potential failures. The pilot may inadvertently over-boost the manifold pressure in a turbo-charged aircraft, typically due to the time lag associated with the throttle position being advanced and the turbo pressure latency. This over-boost can result in a catastrophic failure of the engine if not dealt with in seconds. In fact, an over-boost of as little as 5 inches Hg requires a removal of the engine from the aircraft, with complete disassembly. “Over-boost on Turbo Engines”, Light Plane Maintenance, p. 15 (January 2013). As with the loss of oil pressure, the problem for the pilot is that turbo over-boost is typically only observed by an analog needle, which can easily be missed in the busy cockpit environment.

Another example is failure of the charging system. In this case, the deflection of the analog ammeter is relatively small. But unlike the previous two examples, the pilot has tens of minutes within which to deal with the situation, depending on the state of the battery and the electrical load. But even with tens of minutes available, frequently the first sign of charging system failure is the loss of radio communication or a navigational signal, which presents a potentially dangerous situation, particularly in busy airport environments in IMC. Again, this dangerous situation can be avoided by a timely aural warning to the pilot, affording the time sufficient to address the problem by, for example, finding an alternate airport at which to land.

Given the lack of redundancy in an aircraft, and given that often the pilot is flying without assistance of a co-pilot, what is needed is a system which monitors vital aircraft systems and alerts the pilot promptly when a system fails. These subsystems include oil pressure, the charging system, turbo boost pressure, and vacuum system. Each of these failures has a much greater chance of being dealt with, resulting in a safe outcome of the flight, if the pilot is alerted to the failure at the earliest possible moment. What is needed is an advisory system which is:
Timely;
Aural;
Informative and instructs the pilot on a course of action to counter the problem;
Fully automatic, requiring little or no tactile input from the pilot, i.e. is essentially “hands-free”; and
Customized to the specific make and model of aircraft.

For these reasons, an aural warning system has been developed to assist the pilot by providing timely warnings about abnormal situations and imminent actual or potential threats, serving effectively as an “electronic co-Pilot”. The system is preferably micro-computer based, polling each of the threats independently and frequently (several times per second), and providing an appropriate aural warning specific to the threat. Among the threats monitored in this way are subsystems such as:
Oil pressure failure, as evidenced by monitoring an electric oil-pressure sensor;
Charging system failure, as evidenced by too high or too low a voltage;
Excessive manifold pressure, typically caused by turbo-charger over-boost;
Gear up while attempting to land (for retractable gear aircraft);
Vacuum system failure, which for most airplanes results in a loss of gyroscopic instruments, such as the attitude indicator; and
Starter lock-in (a starter which fails to disengage from the ring gear).

Although it is common to have a “nearest airport” feature on a GPS, there is no known system which in the event of an emergency, for example loss of oil pressure, gives aural assistance as to:
Best glide airspeed, specific to the particular aircraft;
Heading to nearest airport;
Distance to nearest airport; and
Whether or not the aircraft has sufficient altitude to make a landing at the nearest airport, or whether an off-field landing should be considered, based on the best-glide speed specific to the particular aircraft.

Still other objects and advantages of the invention will in part be apparent following a review of the specification and drawings.

### BRIEF DESCRIPTION OF THE SEVERAL VIEWS OF THE DRAWINGS

For a more complete understanding of the invention, reference is made to the following description and accompanying drawings, in which:

FIG. 1 is a diagram of the database inputs to the disclosed system, illustrating one method for creating customized, aircraft make and model specific, information. The majority of the customized information is provided at time of shipping but one feature of the present system is the ability for the end user/installer to use WiFi and a laptop or tablet computer to fine-tune the factory-installed database, e.g. checklists, effectively tailoring the installation to specific needs.

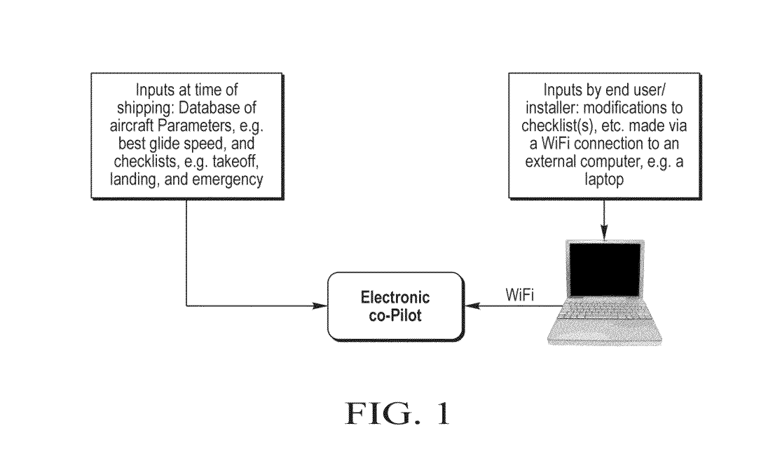

FIG. 2 is a schematic overview of one illustrative form of the disclosed system, illustrating the relationship between aircraft-specific data (e.g., checklists), sensors (e.g., oil pressure), the Bluetooth GPS, the WiFi automatic flight logger (via a webserver), and the audio messages created for the pilot, with voice response.

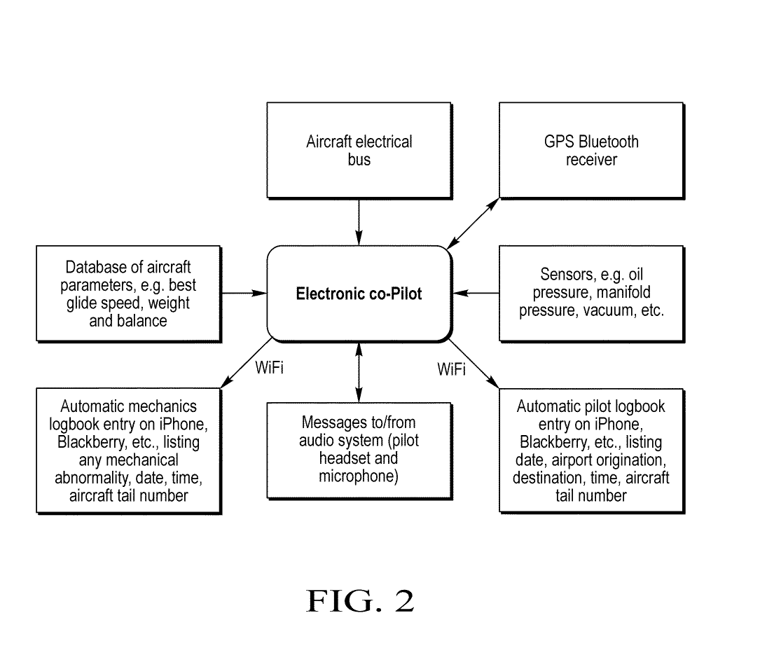

FIG. 3 is a diagram of the speech recognition portion, illustrating two embodiments. The embodiment on the left-side of the figure uses a USB sound card connected directly to the micro-computer and software such as Sphinx or VoxForge. The embodiment on the right utilizes special-purpose hardware to interface directly between the aircraft audio system and the central processing unit of the micro-computer.

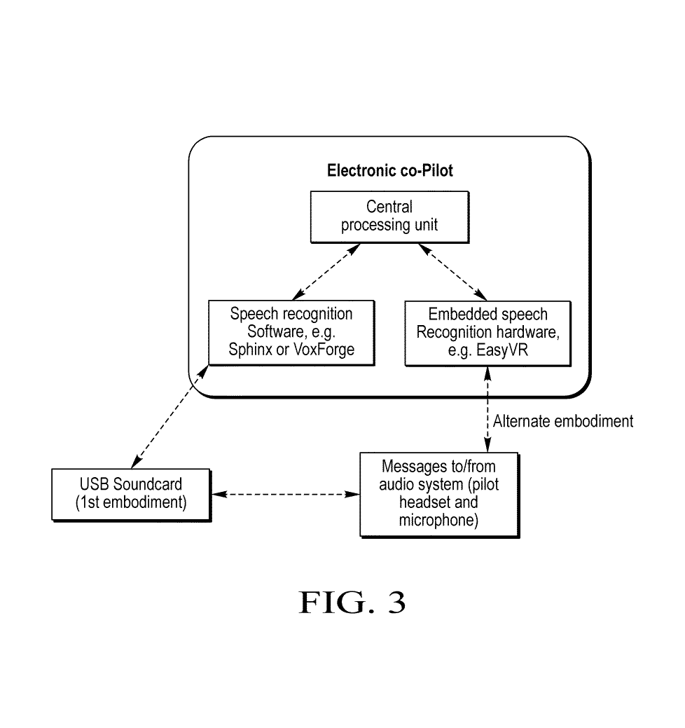

FIG. 4 is the main flowchart depicting one embodiment of the entire system software. After the system initializes the user-defined list of threats to monitor, it initializes the GPS, then continuously scans threats while updating the GPS to determine the “phase of flight” (pre-takeoff, in-flight, or landed). Speech recognition is enabled throughout the flight, providing the pilot with the ability to summon a checklist, for example. This flowchart therefore applies to the general working of the system, detection and response to a threat. Subsequent flowcharts, FIGS. 5-10 depict individual threat detection and response.

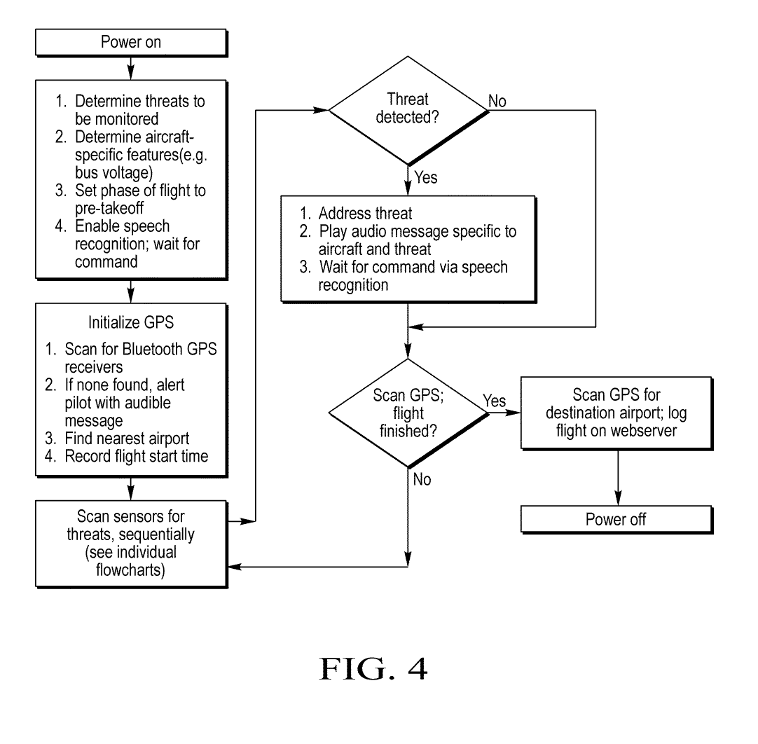

FIG. 5 is a flowchart illustrating the low oil pressure threat and response. Details are provided to the pilot via an aural message announcing not only the threat but useful information for a remedy, including nearest airport, bearing and distance to that airport, best glide speed for the aircraft being flown, and an estimate as to the expected glide distance at that best glide speed. Using speech recognition, the pilot can easily and quickly access the emergency checklist by saying those words (“emergency checklist”), then working through each item on the checklist by saying “check” to acknowledge accomplishing the item.

FIG. 6 is a flowchart for high or low bus voltage. This flowchart illustrates the use of speech recognition, this time for canceling the aural message.

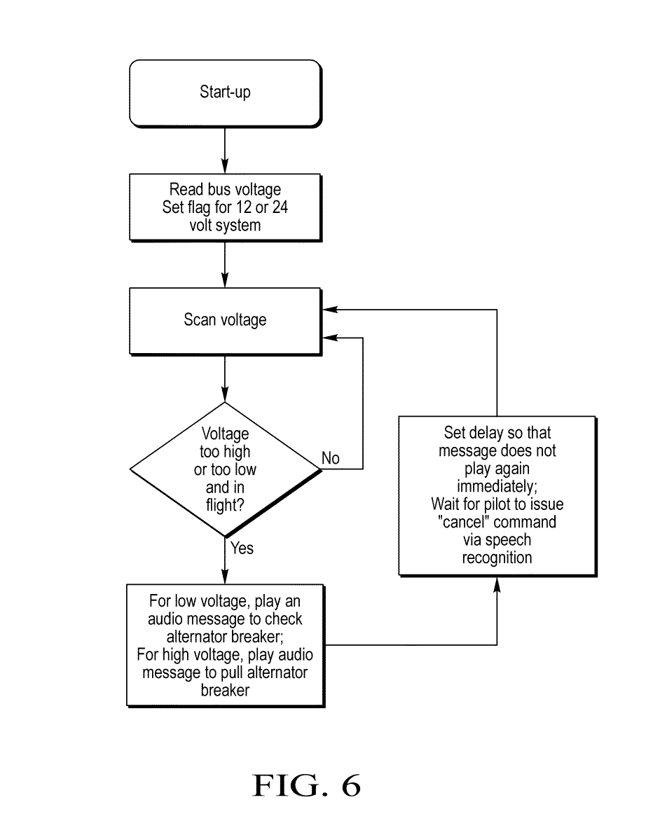

FIG. 7 is a flowchart for high manifold pressure. In this case, the message must be promptly issued because of the detrimental effect on the engine to over-boost by even several seconds.

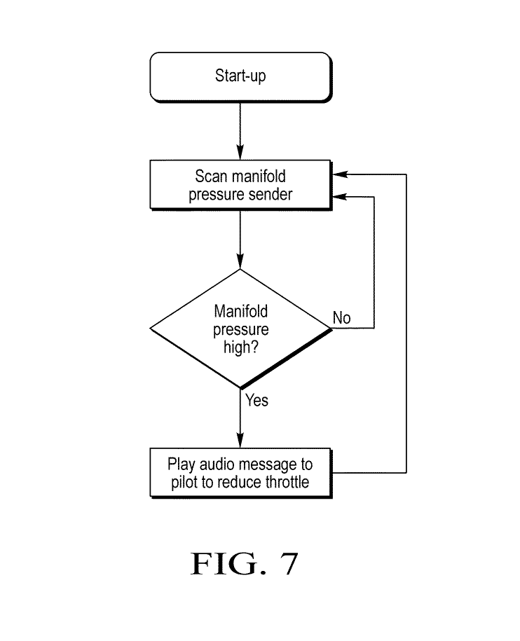

FIG. 8 is a flowchart for warning if a landing seems imminent (suggested by a low manifold pressure) and the landing gear is up.

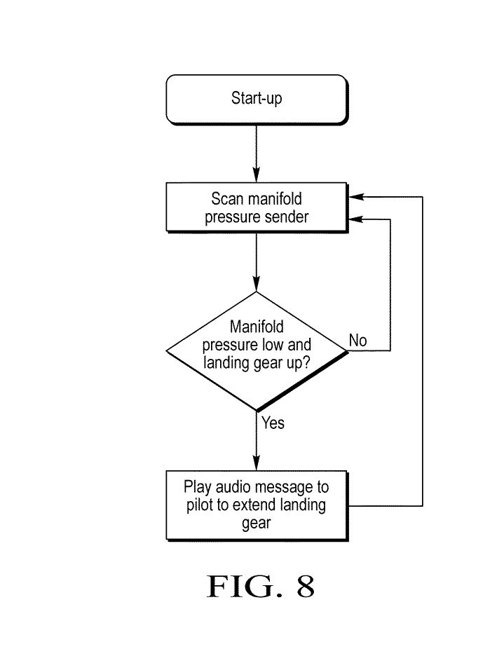

FIG. 9 is a flowchart for vacuum failure. As with the low oil pressure (FIG. 5), it is useful to be able promptly to provide the pilot with key information such as the nearest airport, etc.

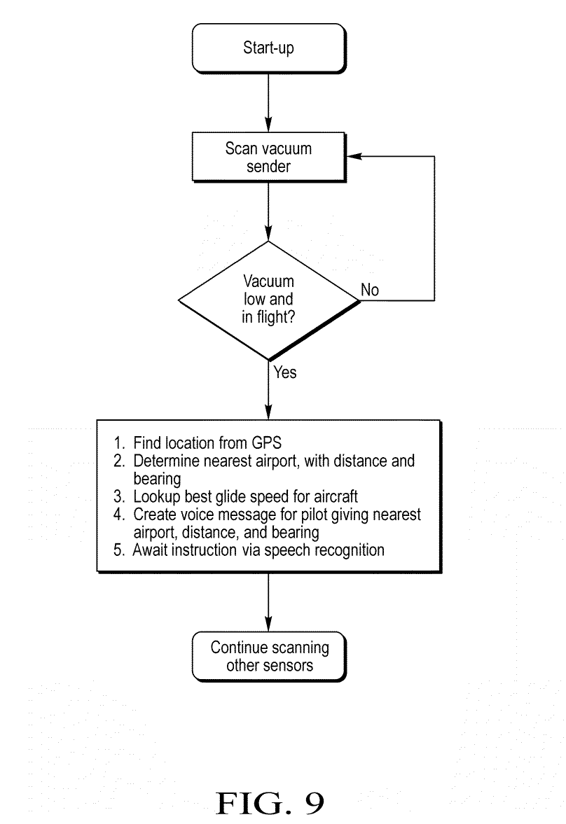

FIG. 10 is a flowchart for starter lock-in, indicating the detection of the threat and the advice given to the pilot to shut down the engine immediately.

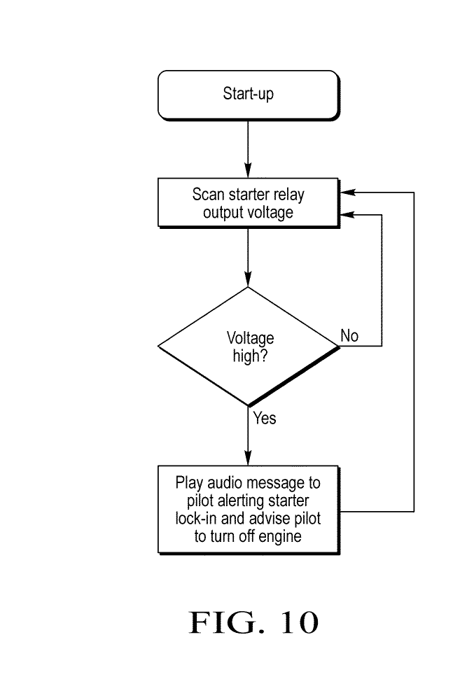

FIG. 11 is a block diagram illustrating one embodiment of the invention and its components.

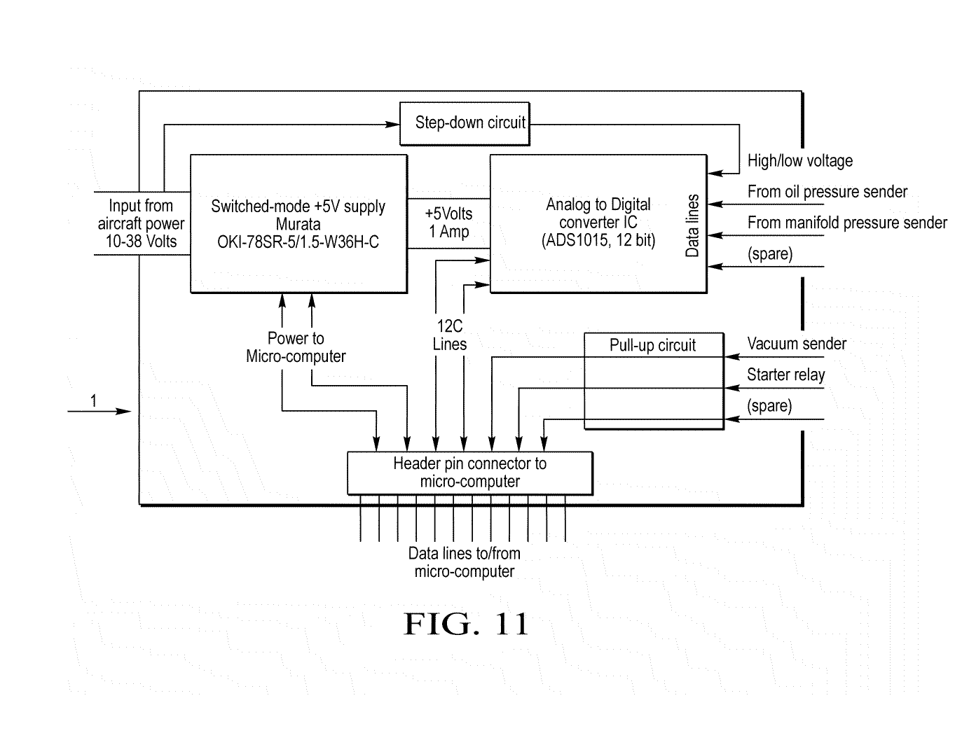

FIG. 12 is a schematic of one embodiment of the system, detailing the various connections to sensors and the micro-computer.

FIG. 13 is a printed circuit board layout of one embodiment, with illustrative component labeling and placement.

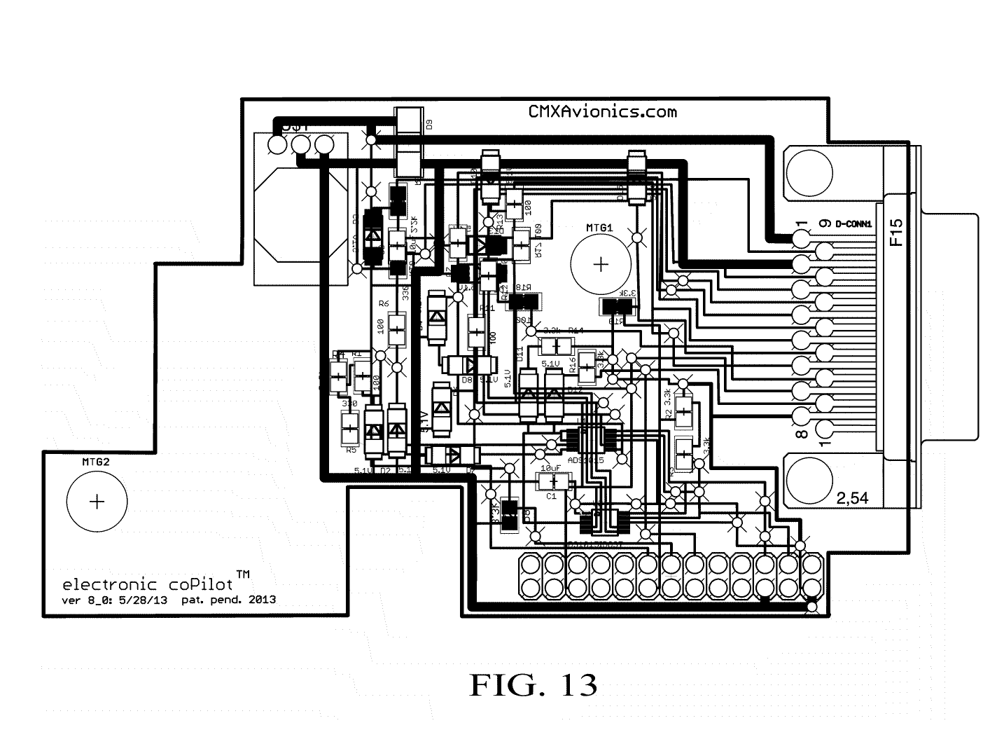

FIG. 14 is an image of one embodiment of the disclosed system (top) mounted on the micro-computer (bottom)

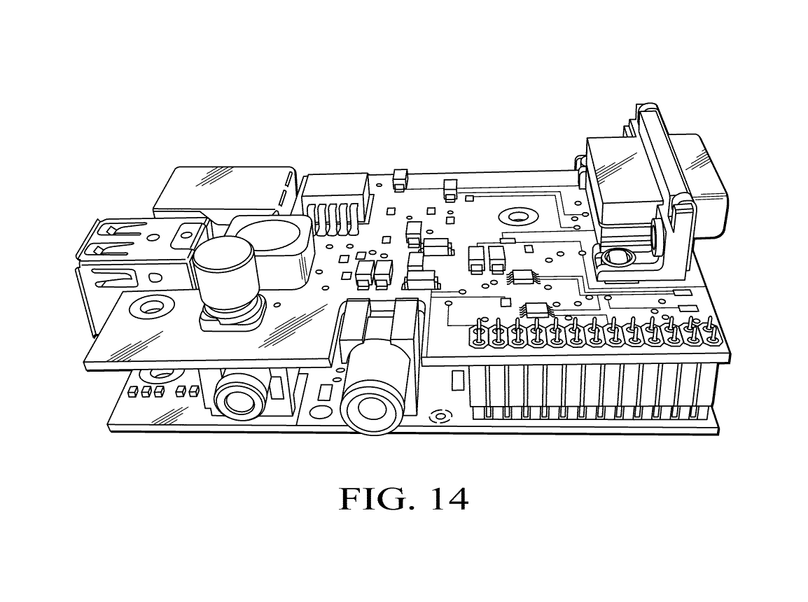

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In order to provide timely and aircraft-specific advice to the pilot when an aircraft system is in jeopardy or fails, a micro-computer based method and system have been developed which interrogates various sensors, interprets the data, then responds by creating aural messages played in the pilot's headset or an overhead speaker recommending a course of action to address the situation.

The disclosed aural warning system helps the pilot by providing timely warnings about abnormal conditions or imminent threats. In this way the system serves many of the roles played by a human co-pilot whose tasks include instrument monitoring and briefing the pilot in command if an abnormal situation is developing.

The micro-computer polls each of the threats independently and frequently, and provides an appropriate aural warning specific to the threat and customized for the aircraft being flown. Examples of threats monitored in this way are:
1. Oil pressure failure, as evidenced by monitoring of an electric oil-pressure sensor;
2. Charging system failure, as evidenced by too high or too low a voltage;
3. Excessive manifold pressure, as evidenced by a manifold pressure gauge, typically caused by turbo over-boost;
4. A gear up configuration when the manifold pressure is below a threshold level, for example while attempting to land (for retractable gear aircraft);
5. Vacuum system failure, which for most planes results in a loss of gyroscopic instruments, such as the attitude indicator; and
6. Starter lock-in (a starter which fails to disengage from the ring gear).

These abnormal situations or potential threats are detected by appropriate sensors, some of which simply indicate an “on” or “off” state (gear up, vacuum system failure, starter lock-in) and are connected to general-purpose input-output (GPIO) pins. Other sensors generate a signal or return a value which must be converted by the micro-computer to a number via an analog-to-digital (ATD) converter. That number correlates to a value which the system deems to be too high or too low. In either case, GPIO or ATD, the micro-computer software is aware of the condition or threat, generates an aircraft-customized aural message, then waits for one or more commands from the pilot. Such commands may be communicated by voice or by manual entry into an on-board instrument, such a depressing a button or turning a knob.

Table 1 is an example of the range of values for the various ATD channels:

TABLE 1
Exemplary Maximum And Minimum Values Of Signals From
Sensors Which Trigger An Audio Message

| Sender | Minimum value | Maximum value |
|---|---|---|
| Oil pressure | 10 psi | None |
| Charging system (12 Volt) | 12.0 V | 15.5 V |
| Charging system (24 Volt) | 24.0 V | 31.0 V |
| Manifold pressure | none | Aircraft - specific, |
| | | typically ~40 inHg |

These commands from the pilot include an acknowledgment of the aural message from the system, such as by the pilot saying “Cancel”. If the pilot needs to be guided by an appropriate checklist, he may request the “Emergency Checklist”. The checklist is then presented to the pilot by the system, again using the audio channel. The pilot may acknowledge accomplishing each checklist task with a response such as “Check.” An alternate embodiment would be a button connected to a GPIO pin that serves as the acknowledge switch.

The disclosed system is advisory. It requires no input from the pilot during start-up, operation, and shutdown. But if desired, inputs can be made via the microphone, audio system, and speech recognition system. The system issues an aural warning if a threat has been determined, and then waits for voice input.

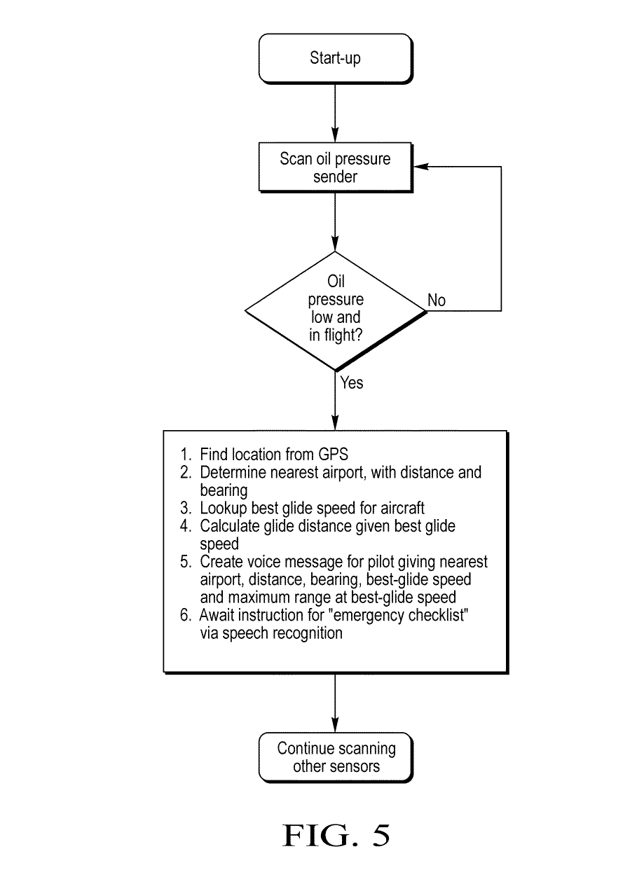

For example, if oil pressure is lost (see FIG. 5), the system issues a message stating that there has been a loss of oil pressure, the nearest airport and the bearing to that airport, the best glide speed for the specific aircraft being flown, and an estimated glide distance at that best glide speed. Several of these parameters for a given aircraft depend on its weight. Optionally, one aspect of the system computes gross weight in flight by subtracting burn rate (gph)×elapsed engine on time (hr) from the aircraft's take-off weight (lb). A table look-up function may then yield best glide speed and estimated glide distance, based on a signal representing altitude, etc. and on the computed gross weight in flight. This best glide speed is then aurally sent to the pilot, thereby eliminating the need for the pilot to find that information in the Pilot Operator's Handbook.

The system then waits for a voice command input from the pilot such as “Computer: Emergency Checklist”. Then the emergency checklist for the specific aircraft being flown is aurally presented to the pilot, one line at a time. The system announces each item in the checklist (emergency checklist in this example), and waits for the pilot to affirm accomplishing the item by saying “Check”. The system then advances to the next item on the checklist.

In a preferred embodiment, a Linux-based micro-computer is used (such as the Raspberry Pi or the BeagleBone system as an alternative embodiment). In either case, the system can be programmed to effectively remove false alarms. Furthermore, processing of the data which is polled can be done in software, such as by calculating a running average. This effectively integrates the data, reducing the chance that noise may incorrectly result in a false alarm.

Another capability resulting from using a micro-computer is that the alarms are programmable at time of shipping so, for example, aircraft which do not have turbo-chargers would not have the alarm for turbo over-boost. This change in the controlling software can be made at the time of shipping.

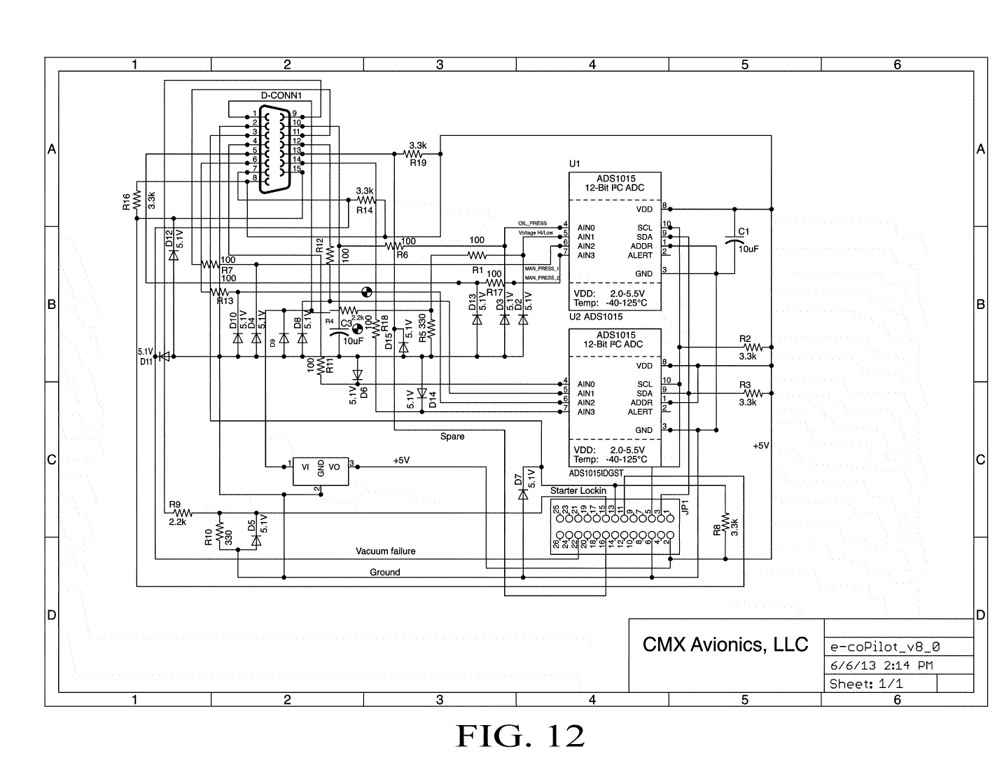

The analog-to-digital interface from the various sensors to the micro-computer is accomplished by, for instance, two Texas Instruments ADS1015 12-bit converters (see the schematic, FIG. 12). These converters are programmable by the micro-computer, making their use flexible in the disclosed system. In addition, general-purpose input/output (GPIO) inputs are utilized, such as for the determination of vacuum failure (which is simply a Boolean 1 or 0).

In one embodiment, the disclosed system is connected to the aircraft power bus (either 14 or 28 volts) and draws approximately one-half ampere, making the power consumption and heat dissipation low. Wireless connections expedite installation, using Bluetooth to connect to a GPS receiver and WiFi to automatically create a webserving “hot-spot” for automated logging of flights to devices such as an iPad, Blackberry, or Android-based personal device. The information automatically logged in this way includes 1): a traditional pilot flight log entry, providing date, aircraft tail number, equipment list, origination and destination airports, and length of time of flight and 2): a mechanic's flight log entry, listing the previous information but, in the event of a detected abnormal sensor reading or sub-system failure, an entry describing the abnormal event, in order to assist a mechanic with repair.

### Automatic Flight Logging System

A preferred embodiment of the system includes a Bluetooth GPS system which, upon aircraft start-up, automatically determines the airport where the flight originates. This is accomplished by software which decodes the stream of NMEA data streamed from the Bluetooth GPS receiver, extracting the latitude and longitude (lat-lon co-ordinates), and then scans a file which contains the lat-lon co-ordinates of every airport. At that point, the system logs the airport identifier (KORD or KLAX, for example), and the time. The system then waits for takeoff, as determined by when the GPS determines that the velocity of the aircraft is greater than taxi speed. During flight, the GPS is periodically monitored in order to determine when the plane has landed, at which point the process before takeoff is repeated and the destination airport is recorded along with the time. This represents essential elements of a log book entry: date, aircraft tail number, FAA equipment list, origination and destination airports and duration of flight.

Once it is determined that a flight has terminated, a socket is created, and the data of the flight log is sent via the socket and a WiFi connection to any previously-authenticated device (iPad, iPhone, Blackberry, etc.) which has a browser of any type (Safari, Explorer, Firefox, etc.). This approach uses a “stoppable” HTTP server, as opposed to the more common “forever” server which continuously issues data. Again, no input from the pilot is required. The only requirements are to be within WiFi range (roughly 15 meters) of a device running a browser which has been authenticated with the disclosed system. Once authenticated, all entries appear on the remote device, without requiring the pilot to perform any action.

In the event that during the flight an abnormal condition or threat is detected, a separate “mechanic's flight log” may be created, using the same technique as described in the previous paragraph. This log entry would contain much of the same information: date, time, aircraft tail number, etc., but would also include information as to the detected abnormality. In this respect, one aspect of the disclosed system is that it may serve as a “black box” which may facilitate aircraft accident or incident investigation and analysis.

### Aural, Voice-Interactive Checklists

The realities of the workloads involved in single pilot operations are that it would be useful for the pilot to be able at short notice to (1) call up aural checklists by voice command or by using a switch, knob or button, (2) confirm completion of a given item on the checklist with a voice command, typically “Check,” or by pressing a single button, and (3) then move on to the next item in the checklist. The system waits for the pilot to accomplish each checklist item, thereby ensuring that none are missed. The checklists are programmed at the time of shipping according to make and model of aircraft. These checklists can be modified by the end user/installer.

In some circumstances, particularly in accident investigations or for mechanical inspections, it may be helpful to create a record of having followed a checklist at a particular date and time, just as it is helpful to have record of having received a weather briefing before flying. Accordingly an optional provision may be made for the system to create an electronic record of the event and related dialog between the pilot and the system. For this purpose, in one embodiment the Pocketsphinx open source speech recognition engine is incorporated into the system. An alternative voice recognition system is VoxForge. Another is to use embedded special-purpose hardware such as EasyVR.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system that provides audio feedback to the pilot of an aircraft, the system comprising:
a) a plurality of sensory interfaces to instruments mounted in the aircraft, the sensory interfaces monitoring an operating condition of an aircraft subsystem and generating signals (Sᵢ) indicative of the operating condition;
b) a microprocessor for
processing the signals (Sᵢ) from the plurality of sensory interfaces,
comparing the signals (Sᵢ) with ranges (Vₘᵢₙ-Vₘₐₓ) of acceptable values thereof indicative of a normal operating range, and
generating one or more diagnostic advisory signals (S_{d}) in response thereto;
c) an audio interface to the microprocessor to enable the pilot to provide commands to the microprocessor; and
d) an audio interface from the microprocessor to the pilot that provides the audio feedback to the pilot depending on the advisory signals (S_{d}) and pilot commands.

2. The system of claim 1 wherein the microprocessor generates an audio announcement to the pilot when a sensed signal (Sᵢ) lies outside the normal operating range (Vₘᵢₙ-Vₘₐₓ), the audio announcement to the pilot including a status indicator and a checklist appropriate to the subsystem condition sensed to assist the pilot in diagnosing and reacting to the sensed condition.

3. The system of claim 2 wherein when a sensor's input (Si) is outside a normal operating range (Vmin-Vmax) for an oil pressure subsystem, the global positioning subsystem receiver is interrogated to obtain the identifier of the nearest airport, which is presented as an aural message to the pilot that includes information including distance, time, and bearing to the nearest airport.

4. The system of claim 1 wherein the audio interface between the microprocessor and the pilot includes a software speech recognizer.

5. The system of claim 1 wherein the audio interface between the microprocessor and the pilot includes a software speech synthesizer.

6. The system of claim 4 wherein the audio interface communicates with a microphone associated with the pilot's headset.

7. The system of claim 5 wherein the audio interface includes a speaker line associated with the pilot's headset.

8. The system of claim 1 further including a global positioning subsystem for monitoring aircraft speed and location with respect to two or three dimensional frames of reference.

9. The system of claim 1 wherein checklists customized to the make and model of the aircraft may be summoned by a voice command.

10. The system of claim 1 wherein the subsystems being monitored include one or more of
an oil pressure sensor;
a electrical subsystem charging sensor;
a manifold pressure sensor;
a landing gear position sensor; and
a vacuum sensor.

11. The system of claim 9 wherein the checklists are presented by a speech synthesizer.

12. The system of claim 1, wherein the sensory interfaces include electrical contacts with transducers and sensors.

13. The system of claim 2 further including means for communicating a signal to the microprocessor that is indicative of aircraft altitude so that the microprocessor may calculate a power-off glide distance based on altitude, weight and best glide speed.

14. The system of claim 1 further including means for creating at start-up an ad hoc network for WiFi connection to one or more authenticated devices selected from the group consisting of an iPad, a tablet computer, an iPhone, a Blackberry, another smartphone and like devices for creating flight log entries.

15. The system of claim 14 wherein the flight log entries are communicated to a remote device via a WiFi connection, using a Bluetooth-connected GPS receiver, the remote device being capable of running a browser such as but not limited to Safari, Explorer and Firefox.

16. The system of claim 15 wherein the log book entries include one or more mechanic's flight log entries with additional information as to the threat or abnormal condition recorded for a mechanic or investigator to interpret.

17. The system of claim 1 further including either a 12 or 24 volt bus without requiring a switch to be set by an installer and means for detecting the bus voltage.

18. A method for providing audio feedback to the pilot of an aircraft, comprising the steps of:
a) mounting a plurality of sensory interfaces upon instruments in the aircraft, the sensory interfaces monitoring an operating condition of an aircraft subsystem and generating signals (Sᵢ) indicative of the operating condition;
b) connecting a microprocessor to the sensory interfaces for
processing the signals (Sᵢ) from the plurality of sensory interfaces,
comparing the signals (Sᵢ) with ranges (Vₘᵢₙ-Vₘₐₓ) of acceptable values thereof indicative of a normal operating range, and
generating one or more diagnostic advisory signals (S_{d}) in response thereto;
c) communicating an audio interface with the microprocessor to enable the pilot to provide commands to the microprocessor; and
d) providing an audio interface from the microprocessor to the pilot that generates the audio feedback to the pilot depending on the advisory signals (S_{d}) and pilot commands.

19. The method of claim 18 further including the step of
(e) initializing the system by setting startup parameters selected from the group consisting of aircraft make and model, initial weight of fuel on board, fuel burn rate and ranges (Vₘᵢₙ-Vₘₐₓ) of acceptable values for aircraft subsystems to be monitored.

20. The method of claim 19 further including the step of
(f) computing the actual weight of the aircraft (Wₐ) as it changes during the flight based on the initial weight of fuel on board, the elapsed time and fuel burn rate;
(g) entering (Wₐ) into an algorithm that calculates glide distance based in part thereon and communicating that glide distance to the pilot.
